(19) United States
(12) Patent Application Publication
(10) Pub. No.: US 2016/0100569 A1
(43) Pub. Date: Apr. 14, 2016

(54) Motion Decoy System for Duck Hunters

(71) Applicant: James William Hudson, Ashland City, TN (US)

(72) Inventor: James William Hudson, Ashland City, TN (US)

(21) Appl. No.: 14/881,419

(22) Filed: Oct. 13, 2015

Related U.S. Application Data
(60) Provisional application No. 62/063,299, filed on Oct. 13, 2014.

(51) Int. Cl. A01M 31/06

(52) U.S. Cl. CPC A01M 31/06

(57) ABSTRACT

A motion decoy system that mimics a flock of birds swimming within a body of water includes a drive unit and a plurality of bird decoys; the drive unit having a frame, a first line, a second line, a trolling motor, and a propeller. The plurality of bird decoys includes a first plurality of decoys pivotally connected to the first line, a second plurality of decoys pivotally connected to the second line, and a third plurality of decoys pivotally connected to the frame. The trolling motor is adjacently connected to the frame and, in conjunction with the propeller, drives the frame forward and backward; the first line and the second line being adjacently connected to the frame opposite each other, wherein the first line and the second line trail the frame. The trolling motor is operated through a control unit that is electrically connected through the second line.

The current application claims a priority to the U.S. Provisional Patent application Ser. No. 62/063,299 filed on Oct. 13, 2014.

### FIELD OF THE INVENTION

The present invention relates generally to an apparatus for water fowl hunting. More specifically, the present invention is a multi-directional motion decoy system that mimics a flock of birds swimming within a body of water.

### BACKGROUND OF THE INVENTION

Waterfowl hunting is the practice of hunting birds such as ducks and geese either for food or for sport. While waterfowl can be hunted in fields, they are most commonly hunted on or near bodies of water such as rivers, lakes, ponds, swamps, etc. Hunters hide in a nearby hunting blind and wait for the waterfowl to approach within range of the blind, wherein the hunter can then shoot the waterfowl, often with a shotgun. In order to lure waterfowl to a particular area it is common practice to use decoys that resemble the particular waterfowl that the hunter is hunting.

The first decoys used for waterfowl hunting were stationary decoys that would be cast out into the body of water, wherein the decoys would float about the surface in order to attract waterfowl. Often there was no way for the hunter to control the decoys and the decoys were anchored in one location so that they did not float away. In order to more realistically portray waterfowl, and in an effort to better attract waterfowl, motion decoys were created. Such motion decoys typically have spinning or moving wings, or are designed to mimic the vertical motion of waterfowl that are feeding by bobbing the decoys up and down. However, these motion decoys do not simulate horizontal movement across the water surface.

Therefore it is the object of the present invention to provide a motion decoy system that mimics a flock of birds swimming within a body of water. The present invention includes a drive unit and a plurality of bird decoys, wherein each of the plurality of bird decoys is designed to mimic the particular type of waterfowl that is being hunted. The drive unit provides a frame, a first line, and a second line for mounting the plurality of bird decoys; the first line and the second line extending from the sides of and trailing behind the frame. The resultant spread formation of the plurality of bird decoys mimics a flock of waterfowl. A trolling motor and propeller are mounted onto the frame, wherein the trolling motor is electrically connected to a battery through the second line and a control unit. The control unit allows the hunter to change the speed and the direction of movement of the plurality of bird decoys from a nearby blind.

### BRIEF DESCRIPTION OF THE DRAWINGS

FIG. 1 is a perspective view of the present invention, wherein the plurality of bird decoys is pivotally connected to the drive unit, and wherein the trolling motor is electrically connected to the battery through the control unit and the second line.

FIG. 2 is a perspective view of frame, the trolling motor, and the propeller, wherein the trolling motor is centrally positioned along the bridge, and wherein the propeller is rotatably connected to the trolling motor.

FIG. 3 is a perspective view of the frame and the third plurality of decoys, wherein the third plurality of decoys is pivotally connected to the first decoy mount and the second decoy mount.

FIG. 4 is a perspective view of the first line and the first plurality of decoys, wherein the first plurality of decoys is pivotally connected to the first line.

FIG. 5 is a perspective view of the second line and the second plurality of decoys, wherein the second plurality of decoys is pivotally connected to the second line.

FIG. 6 is a perspective view of the frame, wherein the frame further comprises the paddle assembly.

### DETAIL DESCRIPTIONS OF THE INVENTION

All illustrations of the drawings are for the purpose of describing selected versions of the present invention and are not intended to limit the scope of the present invention.

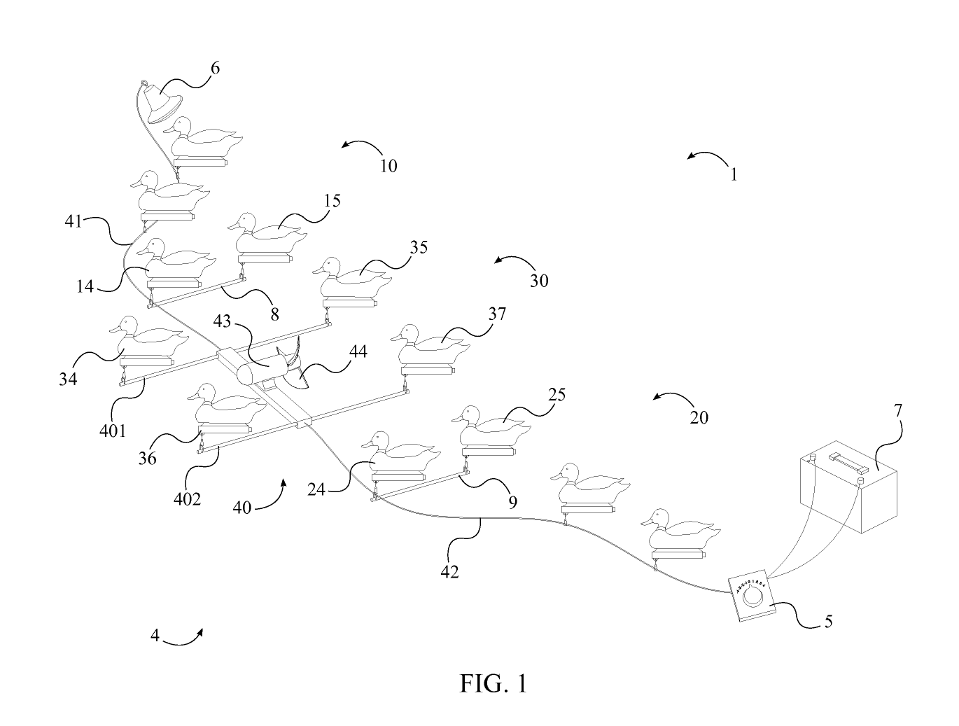

The present invention is a motion decoy system that mimics a flock of birds swimming within a body of water. In reference to FIG. 1, the present invention comprises a plurality of bird decoys 1, a drive unit 4, a control unit 5, an anchor 6, and a battery 7. The plurality of bird decoys 1 is pivotally connected along the drive unit 4, wherein each of the plurality of bird decoys 1 presents a life like presentation of a particular species of bird. In the preferred embodiment of the present invention, each of the plurality of bird decoys 1 is in the form of a duck, however, the plurality of bird decoys 1 may depict any other type of bird in other embodiments of the present invention. The drive unit 4 provides bi-directional movement for the plurality of bird decoys 1 and is operated through the control unit 5. As the drive unit 4 changes direction, each of the plurality of bird decoys 1 pivots 180 degrees mimicking the real life motion of birds changing direction while swimming in a body of water.

In further reference to FIG. 1, the drive unit 4 provides the foundation to which the plurality of bird decoys 1 is attached, in addition to the necessary means for propelling the plurality of bird decoys 1 across the body of water. As such, the drive unit 4 comprises a frame 40, a first line 41, a second line 42, a trolling motor 43, and a propeller 44. The frame 40, the first line 41, and the second line 42 each provide a mounting structure for the plurality of bird decoys 1, while the trolling motor 43 and the propeller 44 provide the means for propelling the frame 40, the first line 41, and the second line 42 across the body of water.

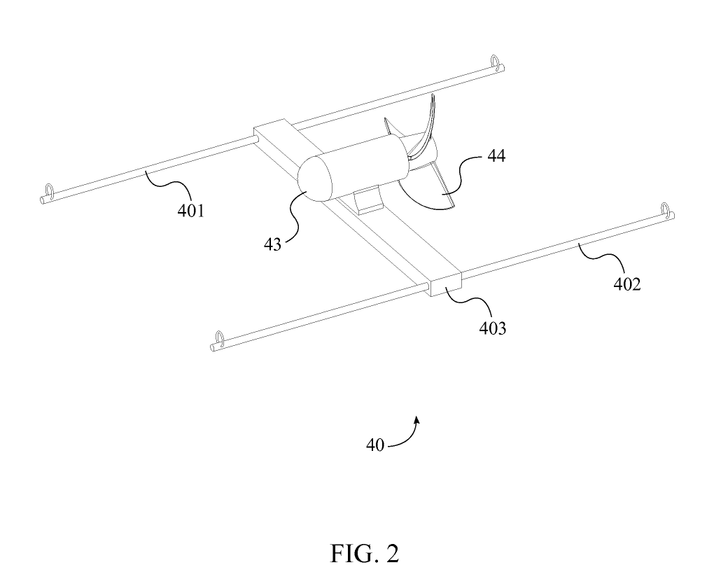

The propeller 44 is rotatably connected to the trolling motor 43, while the trolling motor 43 is adjacently connected to the frame 40, as shown in FIG. 2. The first line 41 and the second line 42 are adjacently connected to the frame 40, wherein the frame 40 is positioned in between the first line 41 and the second line 42, as shown in FIG. 1. The trolling motor 43 and the propeller 44 are oriented to drive the frame 40 forwards and backwards with the first line 41 and the second line 42 being positioned on opposite sides of the frame 40. In this way, as the trolling motor 43 and the propeller 44 drive the frame 40, the first line 41 and the second line 42 extend outwards from the sides of the frame 40 and trail behind the frame 40 in a V-like formation.

The anchor 6 is a weighted object having a density greater than that of water such that the anchor 6 sinks. The anchor 6 is terminally connected to the first line 41 opposite the frame 40, as shown in FIG. 1, wherein the anchor 6 provides a stationary end point for the first line 41 within the body of water. The second line 42 extends on shore to the location of the user, wherein sufficient slack is provided in the first line 41 and the second line 42 in order to allow the frame 40 to move bi-directionally.

In reference to FIG. 1, the control unit 5 is connected in between the second line 42 and the battery 7, wherein the battery 7 is electrically connected to the trolling motor 43 through the control unit 5 and the second line 42. The control unit 5 is operably coupled to the trolling motor 43, regulating the current that is delivered from the battery 7 to the trolling motor 43. The control unit 5 is able to regulate the amount of current, as well as the direction of the current. By changing the direction in which the current flows, the control unit 5 can switch the direction in which the trolling motor 43 drives the propeller 44. By regulating the amount of current, the control unit 5 can determine the speed at which the trolling motor 43 drives the propeller 44 in the given direction. In the preferred embodiment of the present invention, the propeller 44 can be spun at four different speeds in each direction, however, the number of speeds in each direction may vary in other embodiments of the present invention.

In further reference to FIG. 1, the plurality of bird decoys 1 comprises a first plurality of decoys 10, a second plurality of decoys 20, and a third plurality of decoys 30. The first plurality of decoys 10 is pivotally connected to the first line 41, while the second plurality of decoys 20 is pivotally connected to the second line 42; the first plurality of decoys 10 being positioned along the first line 41 and the second plurality of decoys 20 being positioned along the second line 42. Meanwhile, the third plurality of decoys 30 is pivotally connected to the frame 40.

The third plurality of decoys 30 float on the surface of the body of water, while the frame 40 is submerged below the surface. In this way, the frame 40 is concealed such that ducks are not deterred from the movement of an unnatural object. The frame 40 can be suspended from the third plurality of decoys 30, wherein each of the third plurality of decoys 30 is sufficiently buoyant as to support the frame 40, or the frame 40 can be designed with a buoyancy such that the frame 40 floats at a given distance below the surface. The trolling motor 43 is also positioned on the frame 40 such that the trolling motor 43 and the propeller 44 are also fully submerged below the surface.

In reference to FIG. 2, the frame 40 comprises a first decoy mount 401, a second decoy mount 402, and a bridge 403. The first decoy mount 401 and the second decoy mount 402 are adjacently connected to the bridge 403, with the first decoy mount 401 and the second decoy mount 402 being positioned opposite each other along the bridge 403. Furthermore, the bridge 403 is centrally positioned along the first decoy mount 401 and the second decoy mount 402, wherein the frame 40 is H-shaped. The trolling motor 43 is adjacently connected to the bridge 403, while the third plurality of decoys 30 is pivotally connected to the first decoy mount 401 and the second decoy mount 402.

The first decoy mount 401 and the second decoy mount 402 each provide an elongated structure that allows the third plurality of decoys 30 to be longitudinally spaced out. Meanwhile, the bridge 403 provides lateral separation between the first decoy mount 401 and the second decoy mount 402, thus providing lateral separation between the third plurality of decoys 30. Resultantly, the third plurality of decoys 30 is spaced about the frame 40 as to present a natural formation of ducks swimming together.

In the preferred embodiment of the present invention, the trolling motor 43 is centrally positioned along the bridge 403 and is fixed in place in order to provide motion straight forward and backward when the present invention is operated. However, it is also possible for the trolling motor 43 to be positioned off center in other embodiments. It is also possible for the trolling motor 43 to either comprise a rudder or be pivotally connected to the frame 40, wherein the direction of movement can be changed from a straight path. Movement of the rudder or the pivotal movement of the trolling motor 43 would be controlled by the user through the control unit 5.

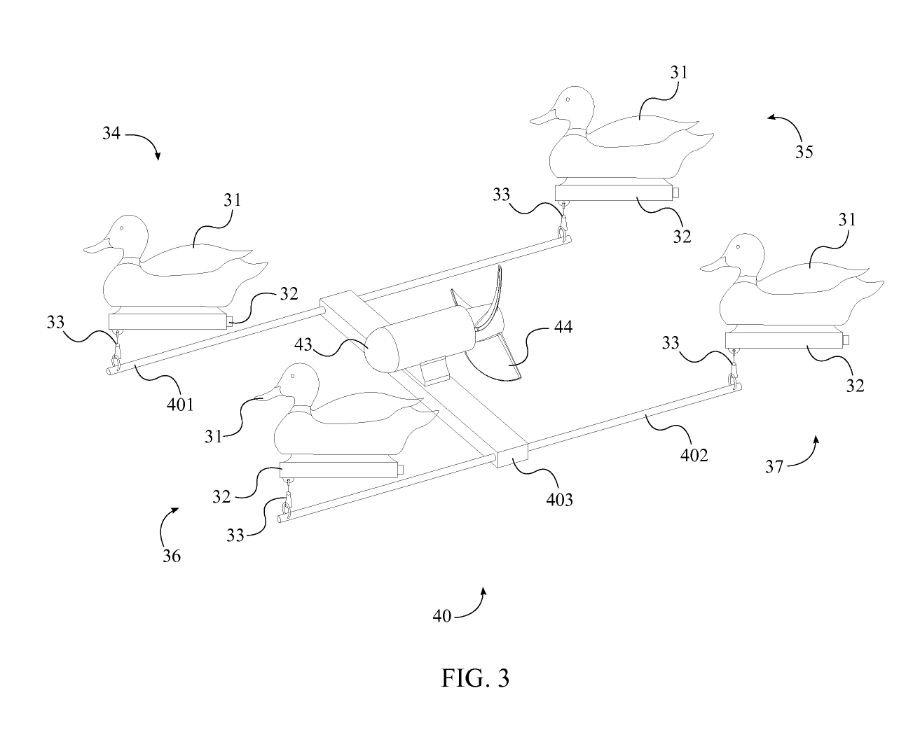

Furthermore, in the preferred embodiment of the present invention, the third plurality of decoys 30 comprises a first decoy 34, a second decoy 35, a third decoy 36, and a fourth decoy 37, as shown in FIG. 3. The first decoy 34 and the second decoy 35 are pivotally connected to the first decoy mount 401, while the third and fourth decoy 37 are pivotally connected to the second decoy mount 402; the first decoy 34 and the second decoy 35 being positioned opposite each other along the first decoy mount 401, and the third decoy 36 and the fourth decoy 37 being positioned opposite each other along the second decoy mount 402. This provides the appearance of a natural separation between each of the third plurality of decoys 30 in order to mimic the separation of ducks swimming in a body of water.

In reference to FIG. 3, each of the third plurality of decoys 30 comprises a third decoy float 31, a third keel 32, and a third pivot connector 33. The third decoy float 31 is a buoyant structure that is in the shape and appearance of a duck or other bird. The third keel 32 is adjacently connected to the third decoy float 31 and is positioned along the third decoy float 31. The third keel 32 is submerged below the third decoy float 31 and the surface of the body of water, and provides a point of connection for the third pivot connector 33 in addition to stabilizing the third decoy float 31. The third pivot connector 33 is adjacently connected to either the first decoy mount 401 or the second decoy mount 402 depending on the positioning of each of the third plurality of decoys 30. The third pivot connector 33 allows each of the third plurality of decoys 30 to rotate 180 degrees as the trolling motor 43 is reversed from a first direction to a second direction.

The third pivot connector 33 is adjacently connected to either the first decoy mount 401 or the second decoy mount 402 for each of the third plurality of decoys 30 that is pivotally connected to the frame 40. In the preferred embodiment of the present invention, the third pivot connector 33 is a swivel snap, however, it is possible for any other connector to be used that allows each of the third plurality of decoys 30 to pivot.

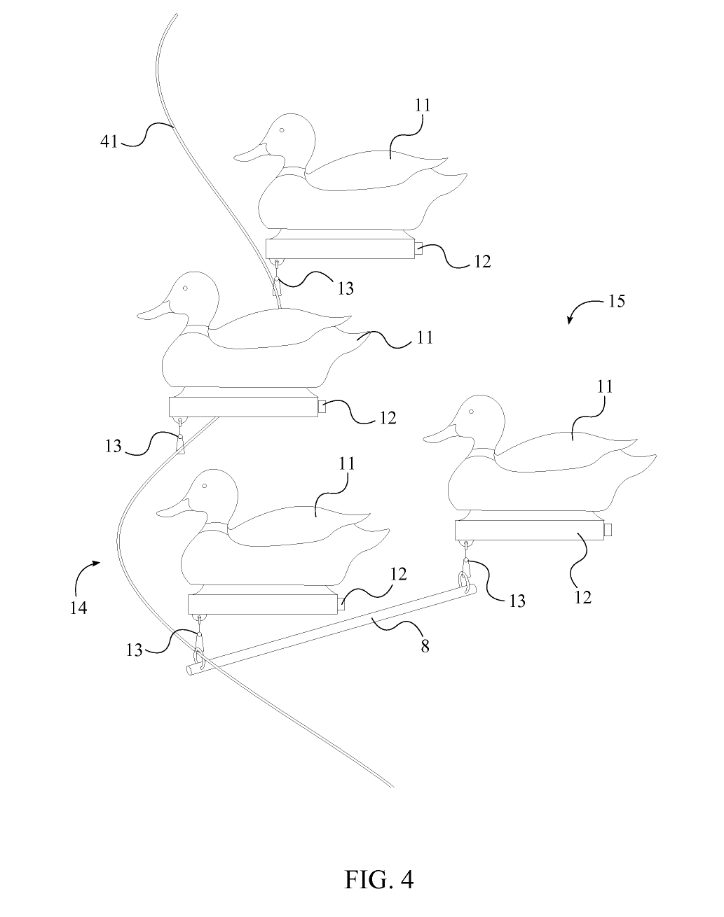

In reference to FIG. 4, each of the first plurality of decoys 10 may be individually connected to the first line 41, or the first plurality of decoys 10 can be pivotally connected to the first line 41 in conjunction with the use of a first spacing rod 8. The first spacing rod 8 is utilized to provide a degree of separation between a pair of decoys from the first plurality of decoys 10, wherein the first plurality of decoys 10 comprises a first leading decoy 14 and a first trailing decoy 15. The first spacing rod 8 provides a degree of separation between the first leading decoy 14 and the first trailing decoy 15 such that each of the first plurality of decoys 10 is not simply positioned in a straight path along the first line 41.

In further reference to FIG. 4, the first leading decoy 14 is pivotally connected to the first line 41, while the first spacing rod 8 is pivotally connected to the first leading decoy 14. Meanwhile, the first trailing decoy 15 is pivotally connected to the first spacing rod 8 opposite the first leading decoy 14. As the frame 40 is propelled in a first direction, the first line 41 and in turn the first leading decoy 14 are pulled in the first direction as well. Subsequently, the first spacing rod 8 and the first trailing decoy 15 are pulled in the first direction, behind the first leading decoy 14.

When the trolling motor 43 is reversed, the frame 40 is propelled in a second direction opposite the first direction, wherein the first line 41 and the first leading decoy 14 are pulled in the second direction. The pivotal connection of the first leading decoy 14 to the first line 41 allows the first leading decoy 14 to spin 180 degrees to give the appearance of forward movement. Meanwhile, the pivotal connection of the first spacing rod 8 to the first leading decoy 14 allows the first spacing rod 8, and in turn the first trailing decoy 15, to spin 180 degrees, wherein the first trailing decoy 15 is pulled behind the first leading decoy 14 in the second direction. The pivotal connection of the first trailing decoy 15 to the first spacing rod 8 allows the first trailing decoy 15 to realistically move as the first spacing rod 8 pivots behind the first leading decoy 14.

In reference to FIG. 4, each of the first plurality of decoys 10 comprises a first decoy float 11, a first keel 12, and a first pivot connector 13. The first decoy float 11 is a buoyant structure that is in the shape and appearance of a duck or other bird. The first keel 12 is adjacently connected to the first decoy float 11 and is positioned along the first decoy float 11. The first keel 12 is submerged below the first decoy float 11 and the surface of the body of water, and provides a point of connection for the first pivot connector 13 in addition to stabilizing the first decoy float 11. The first pivot connector 13 is adjacently connected to either the first line 41 or the first spacing rod 8 depending on the positioning of each of the first plurality of decoys 10. The first pivot connector 13 allows each of the first plurality of decoys 10 to rotate 180 degrees as the trolling motor 43 is reversed from the first direction to the second direction.

In further reference to FIG. 4, the first pivot connector 13 is adjacently connected to the first line 41 for each of the first plurality of decoys 10 that is pivotally connected to the first line 41. When using the first spacing rod 8 in conjunction with the first leading decoy 14 and the first trailing decoy 15, the first pivot connector 13 of the first leading decoy 14 is adjacently connected to the first line 41. Meanwhile, the first pivot connector 13 of the first trailing decoy 15 is adjacently connected to the first spacing rod 8. In the preferred embodiment of the present invention, the first pivot connector 13 is a swivel snap, however, it is possible for any other connector to be used that allows each of the first plurality of decoys 10 to pivot.

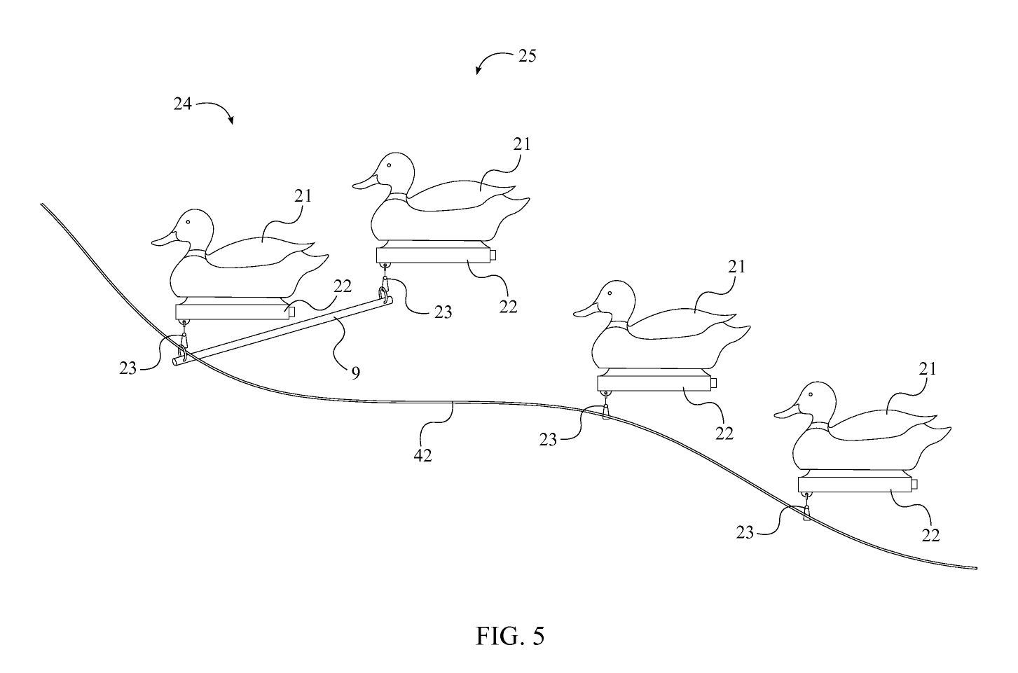

In reference to FIG. 5, similar to the first plurality of decoys 10, each of the second plurality of decoys 20 may be individually connected to the second line 42, or the second plurality of decoys 20 can be pivotally connected to the second line 42 in conjunction with the use of a second spacing rod 9. The second spacing rod 9 is utilized to provide a degree of separation between a pair of decoys from the second plurality of decoys 20, wherein the second plurality of decoys 20 comprises a second leading decoy 24 and a second trailing decoy 25. The second spacing rod 9 provides a degree of separation between the second leading decoy 24 and the second trailing decoy 25 such that each of the second plurality of decoys 20 is not simply positioned in a straight path along the second line 42.

In further reference to FIG. 5, the second leading decoy 24 is pivotally connected to the second line 42, while the second spacing rod 9 is pivotally connected to the second leading decoy 24. Meanwhile, the second trailing decoy 25 is pivotally connected to the second spacing rod 9 opposite the second leading decoy 24. As the frame 40 is propelled in a first direction, the second line 42 and in turn the second leading decoy 24 are pulled in the first direction as well. Subsequently, the second spacing rod 9 and the second trailing decoy 25 are pulled in the first direction, behind the second leading decoy 24. When the trolling motor 43 is reversed, the frame 40 is propelled in a second direction opposite the first direction, wherein the second line 42 and the second leading decoy 24 are pulled in the second direction. The pivotal connection of the second leading decoy 24 to the second line 42 allows the second leading decoy 24 to spin 180 degrees to give the appearance of forward movement. Meanwhile, the pivotal connection of the second spacing rod 9 to the second leading decoy 24 allows the second spacing rod 9, and in turn the second trailing decoy 25, to spin 180 degrees, wherein the second trailing decoy 25 is pulled behind the second leading decoy 24 in the second direction. The pivotal connection of the second trailing decoy 25 to the second spacing rod 9 allows the second trailing decoy 25 to realistically move as the second spacing rod 9 pivots behind the second leading decoy 24.

In reference to FIG. 5, each of the second plurality of decoys 20 comprises a second decoy float 21, a second keel 22, and a second pivot connector 23. The second decoy float 21 is a buoyant structure that is in the shape and appearance of a duck or other bird. The second keel 22 is adjacently connected to the second decoy float 21 and is positioned along the second decoy float 21. The second keel 22 is submerged below the second decoy float 21 and the surface of the body of water, and provides a point of connection for the second pivot connector 23 in addition to stabilizing the second decoy float 21. The second pivot connector 23 is adjacently connected to either the second line 42 or the second spacing rod 9 depending on the positioning of each of the second plurality of decoys 20. The second pivot connector 23 allows each of the second plurality of decoys 20 to rotate 180 degrees as the trolling motor 43 is reversed from the first direction to the second direction.

In further reference to FIG. 5, the second pivot connector 23 is adjacently connected to the second line 42 for each of the second plurality of decoys 20 that is pivotally connected to the second line 42. When using the second spacing rod 9 in conjunction with the second leading decoy 24 and the second trailing decoy 25, the second pivot connector 23 of the second leading decoy 24 is adjacently connected to the second line 42. Meanwhile, the second pivot connector 23 of the second trailing decoy 25 is adjacently connected to the second spacing rod 9. In the preferred embodiment of the present invention, the second pivot connector 23 is a swivel snap, however, it is possible for any other connector to be used that allows each of the second plurality of decoys 20 to pivot.

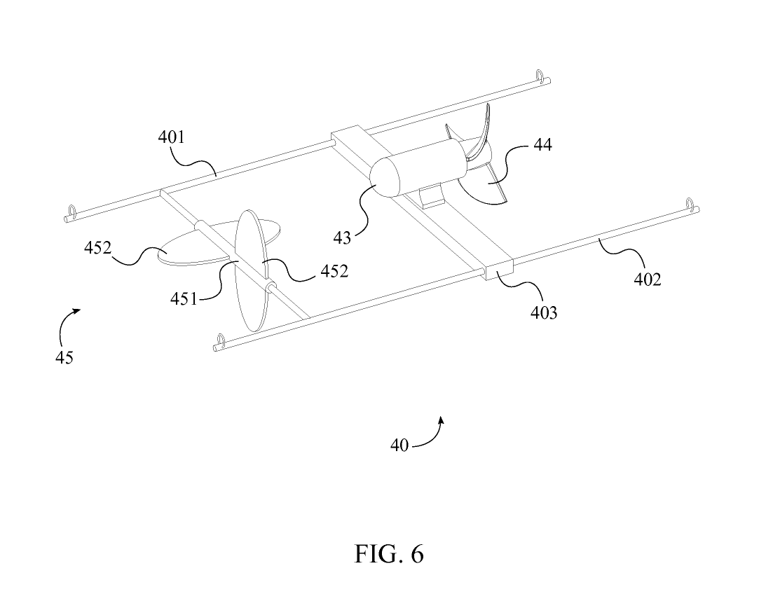

In reference to FIG. 6, in some embodiments of the present invention, the drive unit 4 may further comprise a paddle assembly 45. The paddle assembly 45 is a rotary assembly that creates a splashing on the surface of the water as the frame 40 is propelled forward and backward in order to simulate dabbling ducks tipping up. The paddle assembly 45 comprises a paddle shaft 451 and a plurality of paddles 452, wherein each of the plurality of paddles 452 is designed to resemble the tail end of a duck, or other bird. Each of the plurality of paddles 452 is adjacently connected to the paddle shaft 451, wherein the plurality of paddles 452 is radially positioned around the paddle shaft 451. Preferably, each of the plurality of paddles 452 is mounted on the paddle shaft 451 at a right angle, however, it is possible for the plurality of paddles 452 to be mounted otherwise.

In further reference to FIG. 6, the paddle shaft 451 is rotatably connected to the frame 40 such that the plurality of paddles 452 is rotated through the water as the frame 40 is propelled forward and backward. The paddle shaft 451 is positioned in between the first decoy mount 401 and the second decoy mount 402, wherein the paddle shaft 451 is positioned around a rod that is terminally connected to the first decoy mount 401 and the second decoy mount 402. The position of the paddle shaft 451 around the rod allows the paddle shaft 451, and in turn the plurality of paddles 452, to freely rotate as the frame 40 is propelled through the water.

Although the invention has been explained in relation to its preferred embodiment, it is to be understood that many other possible modifications and variations can be made without departing from the spirit and scope of the invention as hereinafter claimed.

What is claimed is:

1. A motion decoy system comprises:
a plurality of bird decoys;
a drive unit;
a control unit;
the plurality of bird decoys comprises a first plurality of decoys, a second plurality of decoys, and a third plurality of decoys;
the drive unit comprises a frame, a first line, a second line, a trolling motor, and a propeller;
the first line and the second line being adjacently connected to the frame;
the frame being positioned in between the first line and the second line;
the trolling motor being adjacently connected to the frame;
the propeller being rotatably connected to the trolling motor;
the first plurality of decoys being pivotally connected to the first line
the first plurality of decoys being positioned along the first line;
the second plurality of decoys being pivotally connected to the second line;
the second plurality of decoys being positioned along the second line;
the third plurality of decoys being pivotally connected to the frame; and
the control unit being operably coupled to the trolling motor.

2. The motion decoy system as claimed in claim 1 comprises:
an anchor; and
the anchor being terminally connected to the first line opposite the frame.

3. The motion decoy system as claimed in claim 1 comprises:
a battery;
the control unit being connected in between the second line and the battery; and
the battery being electrically connected to the trolling motor through the control unit and the second line.

4. The motion decoy system as claimed in claim 1 comprises:
the frame comprises a first decoy mount, a second decoy mount, and a bridge;
the first decoy mount and the second decoy mount being adjacently connected to the bridge; and
the first decoy mount and the second decoy mount being positioned opposite each other along the bridge.

5. The motion decoy system as claimed in claim 4 comprises:
the bridge being centrally positioned along the first decoy mount and the second decoy mount.

6. The motion decoy system as claimed in claim 1 comprises:
the frame comprises a first decoy mount, a second decoy mount, and a bridge;
the trolling motor being adjacently connected to the bridge; and
the third plurality of decoys being pivotally connected to the first decoy mount and the second decoy mount.

7. The motion decoy system as claimed in claim 6 comprises:
the trolling motor being centrally positioned along the bridge.

8. The motion decoy system as claimed in claim 6 comprises:
the third plurality of decoys comprises a first decoy and a second decoy;
the first decoy and the second decoy being pivotally connected to the first decoy mount; and
the first decoy and the second decoy being positioned opposite each other along the first decoy mount.

9. The motion decoy system as claimed in claim 6 comprises:
the third plurality of decoys comprises a third decoy and a fourth decoy;
the third decoy and the fourth decoy being pivotally connected to the second decoy mount; and
the third decoy and the fourth decoy being positioned opposite each other along the second decoy mount.

10. The motion decoy system as claimed in claim 1 comprises:
a first spacing rod;
the first plurality of decoys comprises a first leading decoy and a first trailing decoy;
the first leading decoy being pivotally connected to the first line;
the first spacing rod being pivotally connected to the first leading decoy; and
the first trailing decoy being pivotally connected to the first spacing rod opposite the first leading decoy.

11. The motion decoy system as claimed in claim 1 comprises:
a second spacing rod;
the second plurality of decoys comprises a second leading decoy and a second trailing decoy;
the second leading decoy being pivotally connected to the second line;
the second spacing rod being pivotally connected to the second leading decoy; and
the second trailing decoy being pivotally connected to the second spacing rod opposite the second leading decoy.

12. The motion decoy system as claimed in claim 1 comprises:
each of the first plurality of decoys comprises a first decoy float, a first keel, and a first pivot connector;
the first keel being adjacently connected to the first decoy float;
the first keel being positioned along the first decoy float; and
the first pivot connector being adjacently connected to the first keel opposite the first decoy float.

13. The motion decoy system as claimed in claim 12 comprises:
the first pivot connector being adjacently connected to the first line.

14. The motion decoy system as claimed in claim 12 comprises:
a first spacing rod;
the first plurality of decoys comprises a first leading decoy and a first trailing decoy;
the first pivot connector of the first leading decoy being adjacently connected to the first line; and
the first pivot connector of the first trailing connector being adjacently connected to the first spacing rod.

15. The motion decoy system as claimed in claim 1 comprises:
each of the second plurality of decoys comprises a second decoy float, a second keel, and a second pivot connector;
the second keel being adjacently connected to the second decoy float;
the second keel being positioned along the second decoy float; and
the second pivot connector being adjacently connected to the second keel opposite the second decoy float.

16. The motion decoy system as claimed in claim 15 comprises:
the second pivot connector being adjacently connected to the second line.

17. The motion decoy system as claimed in claim 15 comprises:
a second spacing rod;
the second plurality of decoys comprises a second leading decoy and a second trailing decoy;
the second pivot connector of the second leading decoy being adjacently connected to the second line; and
the second pivot connector of the second trailing connector being adjacently connected to the second spacing rod.

18. The motion decoy system as claimed in claim 1 comprises:
each of the third plurality of decoys comprises a third decoy float, a third keel, and a third pivot connector;
the third keel being adjacently connected to the third decoy float;
the third keel being positioned along the third decoy float;
the third pivot connector being adjacently connected to the third keel opposite the third decoy float; and
the third pivot connector of each of the third plurality of decoys being adjacently connected to the frame.

19. The motion decoy system as claimed in claim 1 comprises:
the drive unit further comprises a paddle assembly;
the paddle assembly comprises a paddle shaft and a plurality of paddles;
each of the plurality of paddles being adjacently connected to paddle shaft;
the plurality of paddles being radially positioned around the paddle shaft; and
the paddle shaft being rotatably connected to the frame.

20. The motion decoy system as claimed in claim 19 comprises:
the frame comprises a first decoy mount and a second decoy mount; and
the paddle rod being positioned in between the first decoy mount and the second decoy mount.
